(19) United States
(12) Patent Application Publication
(10) Pub. No.: US 2011/0080675 A1
(43) Pub. Date: Apr. 7, 2011

(54) LOW HYSTERESIS BEARING

(75) Inventors: Zine-Eddine Boutaghou, North Oaks, MN (US); Karl G. Schwappach, North Oaks, MN (US)

(73) Assignee: First Principles LLC

(21) Appl. No.: 12/766,429

(22) Filed: Apr. 23, 2010

Related U.S. Application Data
(60) Provisional application No. 61/180,854, filed on May 23, 2009.
(60) Provisional application No. 61/185,998, filed on Jun. 11, 2009.
(60) Provisional application No. 61/187,135, filed on Jun. 15, 2009.

(51) Int. Cl. G11B 5/56; F16C 19/00

(52) U.S. Cl. 360/294; 384/613; G9B/5.201

(57) ABSTRACT

A low hysteresis pivot bearing suitable for a variety of applications. The relationship between torque and angular displacement is substantially linear, with negligible residual hysteresis. The pivot bearing includes a stationary shaft and at least one intermediate member pivotally connected to the stationary shaft by an intermediate member bearing. At least one outer sleeve is pivotally connected to the intermediate member by an outer sleeve bearing. At least one rotary actuator angularly displaces the intermediate member relative to the stationary shaft.

### RELATED APPLICATIONS

The present application claims the benefit of U.S. Provisional Application No. 61/180,854 entitled Low Hysteresis Bearing, filed May 23, 2009; 61/185,998 entitled Low Hysteresis Bearing, filed Jun. 11, 2009; and 61/187,135 entitled Low Hysteresis Bearing, filed Jun. 15, 2009, all of which are hereby incorporated by reference.

### FIELD OF THE INVENTION

The present invention relates to a low hysteresis bearing and control strategies suitable for a variety of applications, including as a pivot bearing for a rotary actuator within disk drives.

### BACKGROUND OF THE INVENTION

Hard disk drives 30, such as illustrated in FIG. 1, employ rotary actuators 32 that position magnetic transducers 34 over selected information tracks on rotating magnetic disks 36. The transducers 34 are positioned with great accuracy by a closed-loop, servo system driven by voice coil motor (VCM) 38. The feedback in the control loop is provided by transducer 34 reading servo information pre-written on the magnetic disk 36.

Rotatable housing 58 on pivot bearing 40 supports rotation of suspension arms 42 through arc 44. In most hard disk drives, the suspension arm 42 is actually a plurality of suspension anus supported by an E-block. (See for example FIG. 3 of U.S. Pat. No. 6,411,471). During track following or track-to-track seek operations, the rotation can be less than one about minute. During seek operations the rotation can be as much as about 20 degrees.

The rotating magnetic disks 36 are subject to spindle run-out 36A. The pivot bearing 40 is subject to frictional resistance and run-out. In order to minimize tracking error, the pivot bearing 40 preferably has low frictional resistance to rotation, minimal run-out, and an evenly distributed pre-load on the bearing assembly.

FIG. 2 illustrates the pivot bearings 40 in greater detail. The pivot bearing 40 employs two spaced sets of ball bearings 50A, 50B (collectively “50”) housed in annular races 52A, 52B (collectively “52”) that are mounted between a shaft 56, and a rotatable housing 58. The shaft 56 is mounted on a base of the disk drive 30 and the rotary actuator 32 is mounted on the rotatable housing 58.

The ball bearings 50A, 50B are pre-loaded so that each exerts a small axial force P on the other to eliminate the internal clearances of the ball bearings 50A, 50B. The pre-load force P has to be adjusted carefully to provide adequate dynamic properties, without increasing the frictional resistance to rotation (torque) of the pivot bearing 40 to an unacceptable extent. If the pre-load P is too high, bearing life will be short, raceway noise will increase, and bearing starting and running torque will increase. If the applied pre-load P is insufficient, corrosion can occur due to vibration causing the balls to resonate and abrade on the raceways. Therefore, obtaining the correct pre-load P is very important.

Both starting torque and running torque are significant to operation of the disk drive 30 and lowering both as much as possible is highly desirable, particularly for high track density applications. Starting torque includes metal-to-metal contact between the ball bearings 50 and the annular races 52, and lubricant shearing. Running torque includes retainer drag (on both ball bearings 50 and the annular races 52) and lubricant churning caused by couplings between balls and retainer, and retainer and raceways. Torque also has a direct effect upon temperature generation, speed variation, power consumption (at start-up and during running), and power consumption variations caused by unstable rotation.

Starting torque is observed in conventional pivot bearings when moving from rest to a steady through a small but finite angle of rotation. A similar transient torque is observed when the direction of rotation is reversed so that, in a pivot bearing undergoing oscillating rotations of small amplitude, the resistance torque traces out a hysteresis loop as a function of angle of rotation. Unfortunately, by the time the pivot bearing is driven out of its stick/slip starting torque state and into rotary movement, excessive driving current may have been applied to the voice coil motor, and the transducer head can be mis-positioned with respect to the desired track position. A system with hysteresis can be summarized as a system that may be in any number of states, independent of the inputs to the system. In the case of a disk drive, torque applied to the pivot bearing does not necessarily correlate to the position of the transducers.

The torque required to rotate a pivot bearing depends on a number of variables, including the elasticity of the ball bearing material, the geometry of the ball bearings, and the nature of the lubricant. During small motions the ball bearings respond to an applied force by deforming elastically. In response to small oscillating rotations of a conventional pivot bearing, the resistance torque traces out a hysteresis loops, such as for example the hysteresis loop as shown in FIG. 3. (Todd et al., A Model for Coulomb Torque Hysteresis in Ball Bearings, Vol. 29, No. 5 International Journal of Mechanical Sciences, pp. 339-354, (1987)). As is illustrated in FIG. 3 the pivot bearing's responses is non-linear. The impact of this dynamic behavior is becoming increasingly important as the data density in disk drives increases.

The current practice in disk drives is to reduce the pre-load on the ball bearing (i.e., the stiffness of the pivot bearing) in order to reduce the elastic deformation of the ball bearings at the races. This reduction in stiffness leads to increased run-out, particularly when the actuator assembly is exposed to vibrations emanating from short and long seeks and external vibrations. The practice of reducing the pivot bearing stiffness in order to improve the track to track seeking of the actuator assembly is leading the industry to migrate to suspension-based micro-actuator to counteract the resulting run-out.

As areal density on a disk drive approaches 1 Terabyte/inch² (1 Tbit/in²) it is expected to increase tracks per inch to about 600,000-800,000 with a spacing between tracks of about 25 nanometers. The hysteresis torque generated in the pivot bearing is becoming increasingly important in high density track recording applications. It is highly desirable to achieve a linear relationship between the required torque and the angular rotation of the suspension arm with negligible residual hysteresis and maximum stiffness of the pivot bearing to meet the high bandwidth requirements.

U.S. Pat. No. 5,755,518 (Boutaghou) discloses a bearing design for a rotatable assembly includes two freely rotating balls mounted on the axis of rotation of the assembly and axially separated, one near each axial end of the assembly. Each ball is confined by a moving concave (preferably conical or frustro-conical) bearing surface of the rotatable assembly and a corresponding fixed concave bearing surface of a mounting attached to a frame, housing, or similar non-rotating structure. One of the fixed mountings is preferably attached to a compressible spring to provide a controlled axial pre-load to the assembly. The balls are substantially enclosed and lubricant provided in the enclosed cavity.

U.S. Pat. No. 5,835,309 (Boutaghou) discloses an arrangement in which two freely rotating balls are mounted on the axis of rotation of an actuator and are axially separated, one at each axial end of the assembly. Each ball in this arrangement is confined by a moving concave bearing surface of the rotatable actuator and a corresponding fixed concave bearing surface of a fixed component. This structure, however, principally improves shock resistance at the expense of increased friction because the area of contact between the balls and the concave bearing surfaces is increased compared with a conventional design using multiple balls in an annular race.

U.S. Pat. No. 6,636,386 (Boutaghou) discloses a disc drive with a base including an axle shaft, a disc stack rotationally mounted to the base, a head assembly coupled to the disc stack, a voice coil and a bearing. The bearing has an inner hub rotationally mounted on the axle shaft, and an outer hub that mounts the voice coil and the head assembly. The outer hub is rotationally mounted to the inner hub through a plurality of flexible spokes that are integrally formed with the inner and outer hubs. The flexible spokes allow the outer hub to rotate when the inner hub is stopped by stiction, also referred to as starting torque. Integral forming provides a predictable response desired for a disc drive.

Other examples of pivot bearings are disclosed in U.S. Pat. No. 6,963,472 (Heath); U.S. Pat. No. 6,631,053 (Chew); U.S. Pat. No. 6,205,005 (Heath); U.S. Pat. No. 5,559,652 (Heath et al.); and U.S. Pat. Publication No. 2002/0101688 (Liu et al.). Various alternatives such as knife edge type pivot bearings are disclosed in Lawsen (U.S. Pat. No. 6,078,475); Liu et al. (U.S. Pat. No. 6,411,471); Oveyssi (U.S. Pat. No. 6,856,492); Boutaghou (U.S. Pat. No. 5,755,518); and Schulze (U.S. Pat. No. 5,355,268). Knife edge bearings have met with major cost, reliability and manufacturing drawbacks. Knife edge designs do not resolve the intrinsic problem of elastic deformation between the knife edge and the supporting structure during micro-actuation. The knife edge pivots also have very low stiffness leading to impractical translation modes of the suspension arm.

### BRIEF SUMMARY OF THE INVENTION

The present invention is directed to a low hysteresis pivot bearing suitable for a variety of applications. The relationship between torque and angular displacement is substantially linear, with negligible residual hysteresis. The present pivot bearing also decouples stiffness from hysteresis, without increasing translation error.

One embodiment is directed to a pivot bearing for use in a rotary actuator of a hard disk drive. The pivot bearing includes a stationary shaft and at least one intermediate member pivotally connected to the stationary shaft by an intermediate member bearing. At least one outer sleeve is pivotally connected to the intermediate member by an outer sleeve bearing. At least one rotary actuator angularly displaces the intermediate member relative to the stationary shaft. The intermediate member can be a sleeve, a bearing race, or a rotatable center shaft, or a combination thereof.

The rotary actuator can be coupled to a side surface or distal end of the intermediate member. In one embodiment, the rotary actuator is a DC or a voice coil motor.

In one embodiment, the intermediate member rotates continuously between about 1 revolution per minute to about 10 revolutions per minute. In another embodiment, the intermediate member moves intermittently, such as for example immediately prior to the actuator arm moving the transducer head.

In another embodiment, hydrodynamic features are provided at one or more interfaces between the stationary shaft, the intermediate member, and the outer sleeve. The intermediate member is then rotated at a sufficient rate to generate an air bearing or hydrodynamic film at the interfaces.

In one embodiment, the intermediate member is not powered by a motor. Rather, the intermediate member is free to spin due to the rotation of the inner and outer ball bearings when torque is applied by the voice coil actuation. The constraints on the ball bearings are reduced, thus substantially reducing the hysteresis effects.

The outer sleeve bearings and intermediate members bearing typically include an upper bearing set and a lower bearing set. In one embodiment, the intermediate member includes an upper portion with a first rotary actuator and a lower portion with a second rotary actuator. The upper portion of the intermediate member can be angularly displaced in the same or opposite direction from the lower portion. In another embodiment, the intermediate member includes a first intermediate member pivotally connected to the stationary shaft by a first intermediate member bearing, and a second intermediate member pivotally connected concentrically to the first intermediate member by a second intermediate member bearing. First and second rotary actuators are provided to angularly displace the first and second intermediate members relative to the stationary shaft. The first intermediate member and the second intermediate member can be angularly displaced in the same or opposite directions.

The relationship of torque applied to the pivot bearing to angular displacement of the pivot bearing is preferably substantially linear. A controller can be programmed to actuate the rotary actuator only during position critical displacement. The angular displacement of the intermediate member displaces the bearing to minimize formation of meniscus films of lubricant on the inner and outer sleeve bearings.

The present invention is also directed to a hard disk drive including a suspension atm that position magnetic transducers over selected information tracks on rotating magnetic disks. The pivot bearing rotatably supports at least one suspension atm relative to the rotating magnetic disks. The pivot bearing includes at least one intermediate member pivotally connected to the stationary shaft by an intermediate member bearing, at least one outer sleeve pivotally connected to the intermediate member by an outer sleeve bearing, and at least one rotary actuator adapted to angularly displace the intermediate member relative to the stationary shaft.

In one embodiment, a controller actuates the rotary actuator only during position critical displacement. The controller can be a servo controller for a hard disk drive or a separate device. The controller can be programmed to rotate the intermediate member continuously or intermittently. The controller can also be programmed to angularly displace the intermediate member in a same direction or opposite direction of rotation of the outer sleeve. In one embodiment, the controller is programmed to apply one of a current or voltage to a voice coil motor attached to the suspension arm that is proportional to a current or voltage applied to the rotary actuator.

In another embodiment, pulses of current are delivered to the rotary actuator on the pivot bearing immediately prior to, or simultaneously with, current or voltage being applied to the voice coil motor on the actuator arm. The pulses preferably angularly displace the intermediate member in the same direction the actuator arm will rotate.

The present invention is also directed to a method of operating a hard disk drive.

At least one suspension arm is supported by an outer sleeve of a pivot bearing. An intermediate member of the pivot bearing arranged concentric with the outer sleeve is rotated relative to a stationary shaft. The suspension arms and the outer sleeve are rotated independently from the rotation of the intermediate member to position magnetic transducers attached to the suspension arms over selected information tracks on rotating magnetic disks.

### BRIEF DESCRIPTION OF THE SEVERAL VIEWS OF THE DRAWING

FIG. 1 is a schematic illustration of a hard disk drive.

FIG. 2 is a schematic illustration of a pivot bearing for the hard disk drive of FIG. 1.

FIGS. 3a and 3b are an exemplary hysteresis curve for a prior art pivot bearing.

FIG. 4 is a side sectional view of a pivot bearing in accordance with an embodiment of the present invention.

FIG. 5 is a perspective view of the pivot bearing of FIG. 4.

FIG. 6 is an exploded view of the pivot bearing of FIG. 4.

FIG. 7 is a graph of a torque displacement curve for a pivot bearing in accordance with an embodiment of the present invention.

FIG. 8A is a schematic illustration of a pivot bearing with upper and lower intermediate members in accordance with an embodiment of the present invention.

FIG. 8B is a schematic illustration of a pivot bearing with a voice coil motor in accordance with an embodiment of the present invention.

FIG. 8C is a schematic illustration of a pivot bearing with a voice coil motor outside the pivot bearing envelope in accordance with an embodiment of the present invention.

FIG. 9A is a schematic illustration of a pivot bearing with an external motor driving the intermediate member in accordance with an embodiment of the present invention.

FIG. 9B is a schematic illustration of a pivot bearing with first and second intermediate members in accordance with an embodiment of the present invention.

FIG. 9C is a schematic illustration of a pivot bearing without rotary actuators in accordance with an embodiment of the present invention.

FIG. 10 is an exploded view of a pivot bearing with air bearing surfaces in accordance with an embodiment of the present invention.

FIG. 11 is a side sectional view of the pivot bearing of FIG. 10.

FIG. 12 is a perspective view of a stationary bearing shaft of the pivot bearing of FIG. 10.

FIG. 13 is a perspective view of an intermediate member of the pivot bearing of FIG. 10.

FIG. 14 is a perspective view of an outer sleeve bearing shell of the pivot bearing of FIG. 10.

FIG. 15 is a schematic illustration of a disk drive with a pivot bearing in accordance with an embodiment of the present invention.

FIG. 16 is a schematic illustration of a disk drive with an alternate pivot bearing in accordance with an embodiment of the present invention.

FIG. 17A is a schematic illustration of a pivot bearing where intermediate member is a rotatable bearing race in accordance with an embodiment of the present invention.

FIG. 17B is a schematic illustration of a pivot bearing of FIG. 17A with a voice coil motor located outside of the pivot bearing envelope in accordance with an embodiment of the present invention.

FIG. 18A is a schematic illustration of a pivot bearing where intermediate member is a rotatable center shaft in accordance with an embodiment of the present invention.

FIG. 18B is a schematic illustration of an alternate pivot bearing where intermediate member is a rotatable center shaft in accordance with an embodiment of the present invention.

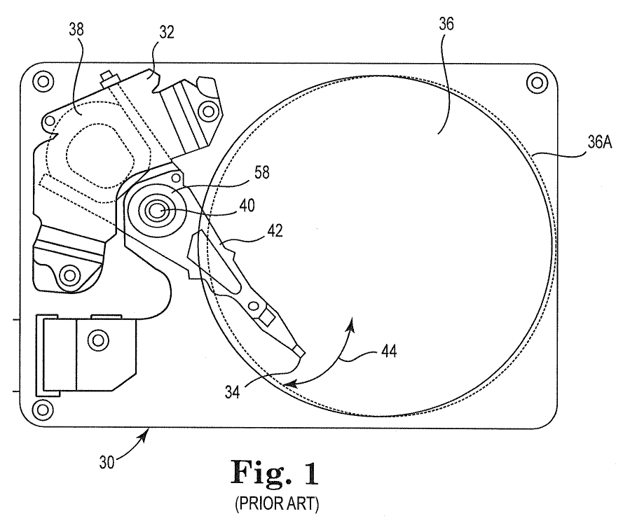

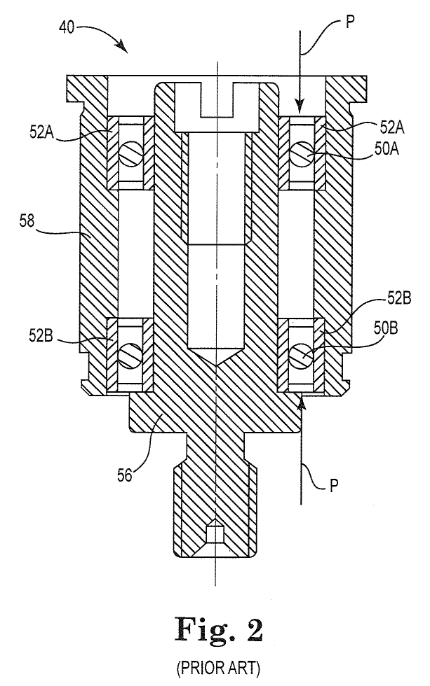

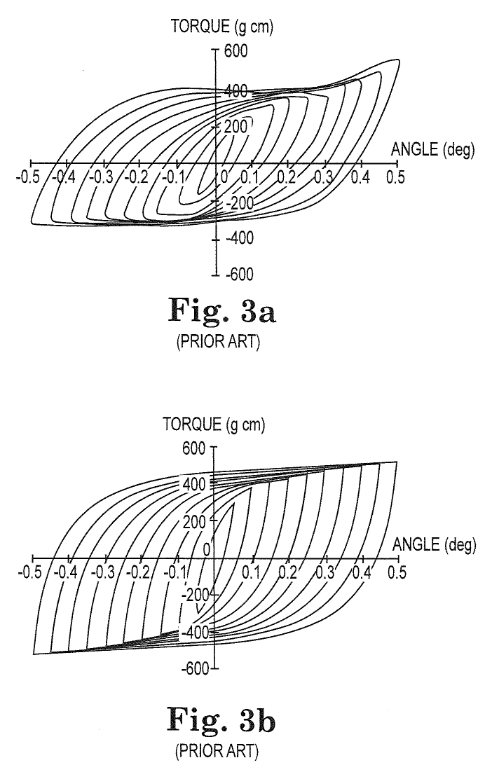

### DETAILED DESCRIPTION OF THE INVENTION

The entire content of U.S. Provisional Application No. 61/180,854, filed May 23, 2009; 61/185,998, filed Jun. 11, 2009; and 61/187,135, filed Jun. 15, 2009 is hereby incorporated by reference.

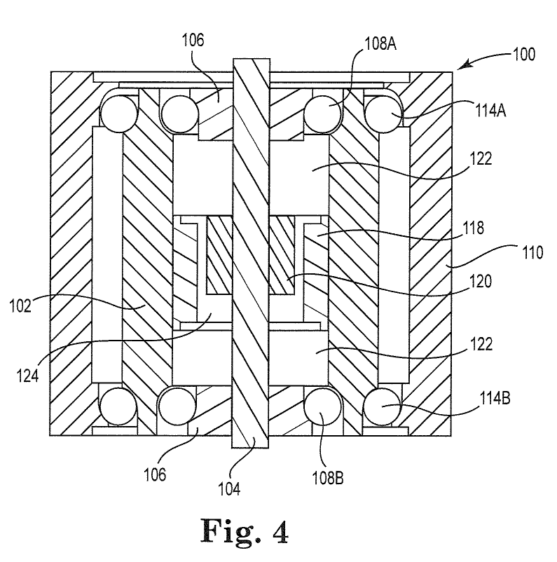

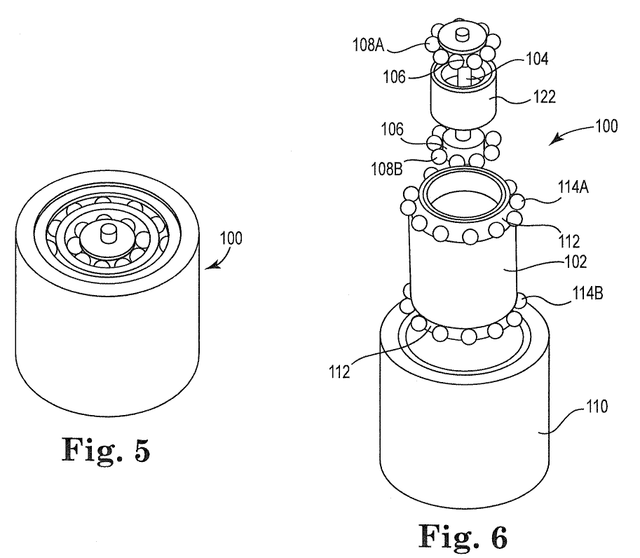

FIGS. 4 through 6 are various views of a pivot bearing 100 in accordance with an embodiment of the present invention. Intermediate member 102 is pivotally supported on stationary shaft 104 by intermediate member bearings 106. In the illustrated embodiment, the intermediate member bearings 106 include upper bearing set 108A and lower bearing set 108B (collectively “108”). Consequently, the intermediate member 102 can be angularly displaced concentrically around the stationary shaft 104. As will be discussed below, the intermediate member bearings 106 can be subjected to a substantial pre-load without creating excessive hysteresis. In an alternate embodiment, the intermediate member bearings 106 can be fixedly mounted to the intermediate member 102.

The present embodiment contemplates the intermediate member 102 able to rotate 360 degrees. In other embodiments, however, only a small degree of angular displacement is required to overcome the stiction forces. As used herein, “pivot” or “pivotable” refer to a capacity for at least some small amount of angular displacement. Complete rotation is not required. For example, displacing the intermediate member a few degrees may be sufficient to overcome the hysteresis effect.

Outer sleeve 110 is rotatably supported on intermediate member 102 by outer sleeve bearings 112 (see FIG. 6). In the illustrated embodiment, the outer sleeve bearings 112 includes upper bearing set 114A and a lower bearing set 114B (collectively “114”). The outer sleeve bearings 112 are fixedly mounted to either the outer sleeve 110 or the intermediate member 102. Consequently, the outer sleeve 110 is free to rotate concentrically around the intermediate member 102 and the stationary shaft 104.

The bearing sets 108, 114 include pre-loaded ball bearings. The pre-load is provided to impart axial and/or radial stiffness to the pivot bearing 100. Stiffness is proportional to the translation mode and is critical to the bandwidth of the servo system in high density disk drives. The increase in translation stiffness mitigates the effects of external vibrations and reduces tracking errors during read write operations.

Rotary actuator 116 is located between the stationary shaft 104 and the intermediate member 102. In the illustrated embodiment, flanges 122 create separation 124 between the intermediate member bearings 106 in which the rotary actuator 116 is located. The flanges 122 may also provide support for the intermediate member bearings 106.

In one embodiment, rotary actuator 116 is a DC motor with a magnet 118 mounted to the intermediate member 102 and a stator 120 mounted to the stationary shaft 104. The rotary actuator 116 rotates the intermediate member 102 relative to the stationary shaft 104, even if the outer sleeve 110 is stationary. In another embodiment, rotary actuator 116 is a voice coil motor. The rotary actuator 116 can be internal or external to the pivot bearing 100, as will be discussed in more detail below.

Angular displacement of the intermediate member causes the bearing sets 108, 114 to be in motion, eliminating the starting torque normally generated by the intermediate member bearing 106 and/or the outer sleeve bearing 112. The need to move the ball bearings 108, 114 out of a stick/slip state into rotary movement is also eliminated. Moving bearings 108, 114 also displace the lubricant and prevent a meniscus film of lubricant that causes stiction from forming. As a result the transient torque observed during start-up from a resting state, or when the direction of rotation is reversed, is substantially eliminated.

The power consumed by the rotary actuator 116 is small since the rotational speed is preferably about 1 to about 10 revolutions per minute. In another embodiment, the rotary actuator 116 is turned-off except during position critical displacement. As used herein, “position critical displacement” refers to track following, track-to-track seek operations, and other positioning activities that require high accuracy.

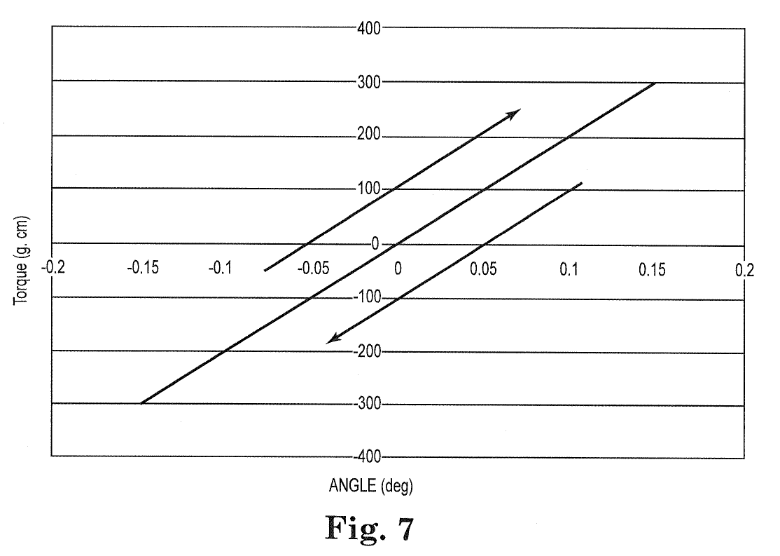

As illustrated in FIG. 7 the relationship between torque and angular displacement is substantially linear, with negligible residual hysteresis. The stiffness of the pivot bearing 100 is hence decoupled from the hysteresis loop, reducing translation error.

During the rotation of the intermediary sleeve 102, a repeatable run-out motion is generated. In one embodiment, the pivot bearing 100 repeatable run-out is synchronized to the spindle run-out.

Depending on the rotational speed of the intermediary sleeve 102, a bias force may be transmitted to the outer sleeve 110. U.S. Pat. No. 7,031,098 (Park) compares several approaches to compensate for bias forces due to flex, which can be used to compensate for this bias.

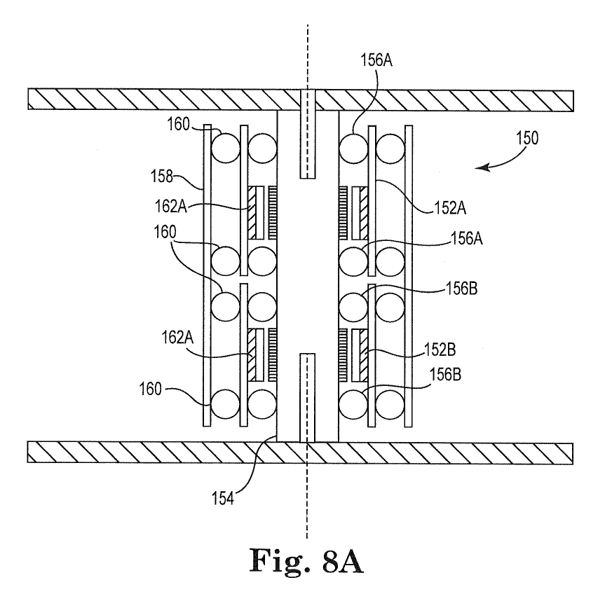

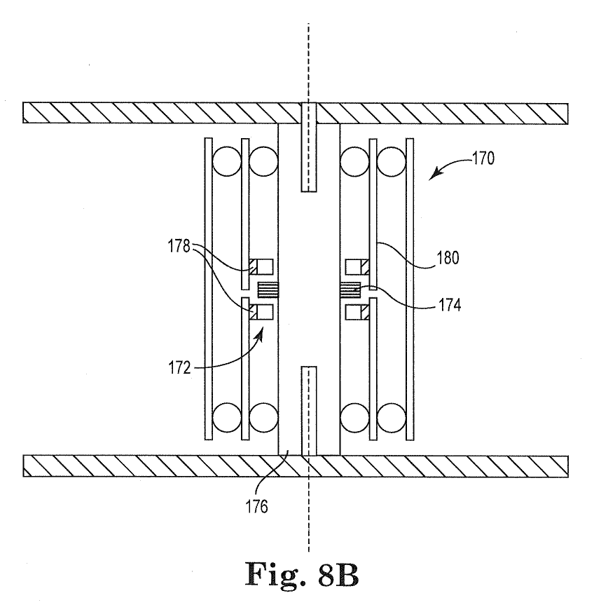

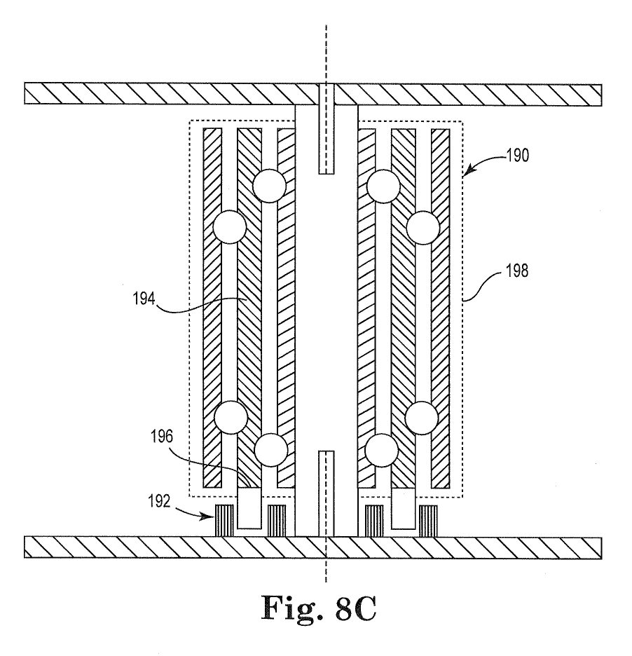

FIG. 8A is a schematic illustration of an alternate pivot bearing 150 in accordance with an embodiment of the present invention. An upper intermediate members 152A and a lower intermediate member 152B (collectively “152”) are rotatably supported on stationary shaft 154 by intermediate member bearings 156A, 156B, respectively. The pair of intermediate members 152 can rotate independently around the stationary shaft 154. Outer sleeve 158 is rotatably supported on intermediate members 152 by outer sleeve bearings 160.

A pair of rotary actuator 162A, 162B (collectively “162”) are located between the stationary shaft 154 and the intermediate members 152. The rotary actuators 162 permit the intermediate members 152 to be rotated at different speeds and/or in different directions, even when the outer sleeve 158 is stationary. In one embodiment, the intermediate members 152 are counter rotated to substantially neutralize torque transmitted from the rotary actuators 162 to the outer sleeve 158.

FIG. 8B is a schematic illustration of an alternate pivot bearing 170 with a voice coil motor 172 in accordance with an embodiment of the present invention. Coil 174 is mounted to the stationary shaft 176 and the magnets 178 are mounted to intermediate member 180.

FIG. 8C is a schematic illustration of an alternate pivot bearing 190 in which voice coil motor 192 is located at distal end 196 of intermediate member 194. Consequently, the embodiment of FIG. 8C permits the pivot bearing 190 to have substantially the same diameter 196 as existing pivot bearings. The voice coil motor 192 is located substantially outside the conventional outer boundaries or design envelope 198 allocated in the disk drives for conventional pivot bearing. By reducing the height of the pivot bearing 200, design changes to the disk drive can be minimized.

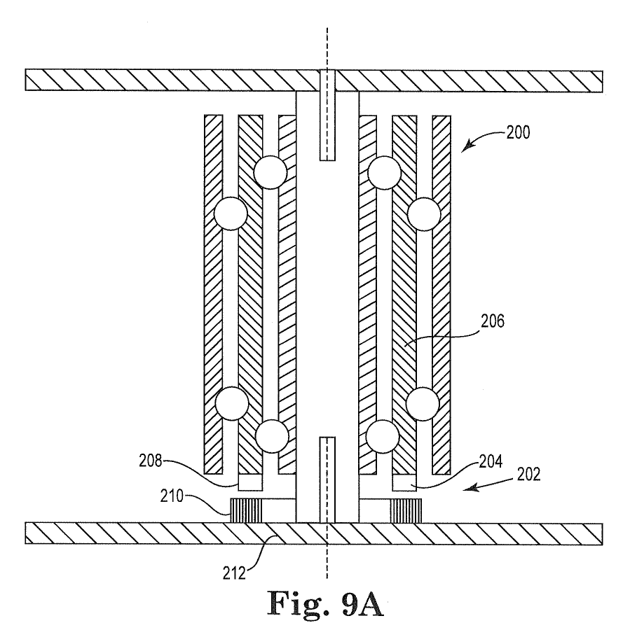

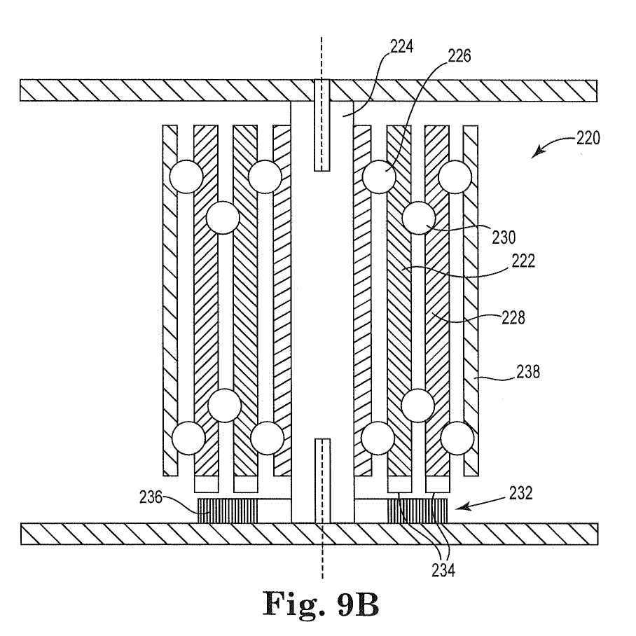

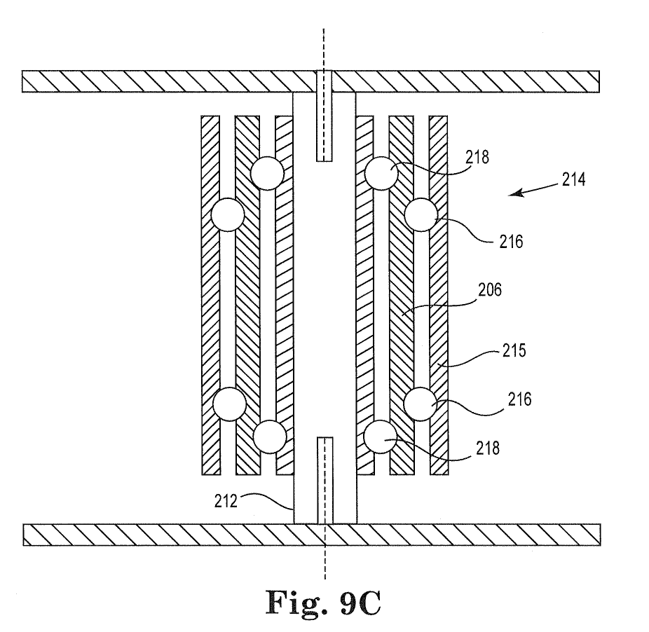

FIG. 9A is a schematic illustration of an alternate pivot bearing 200 in accordance with an embodiment of the present invention. Rotary actuator 202 is located at distal ends 204 of intermediate member 206. In the illustrated embodiment, rotary actuator 202 is a DC motor with a magnet 208 mounted to distal end 204 of the intermediate member 202 and a stator 210 mounted to the stationary shaft 212. The rotary actuator 202 is also located outside of the conventional design envelope of the pivot bearing 200.

FIG. 9B is a schematic illustration of an alternate pivot bearing 220 in accordance with an embodiment of the present invention. First intermediate member 222 is rotatably supported by stationary shaft 224 by first intermediate member bearings 226. Second intermediate member 228 is arranged concentrically with the first intermediate member 222, and rotatably supported by second intermediate member bearings 230. Rotary actuators 232 are located at distal ends of the first and second intermediate members 222, 228. In the illustrated embodiment, rotary actuator 232 is a DC motor with magnets 234 mounted to distal end of the first and second intermediate members 222, 228 and stator 236 mounted to the supporting shaft 224. The first and second intermediate members 222, 228 can rotate in the same direction or be counter-rotated to minimize the torque on outer sleeve 238.

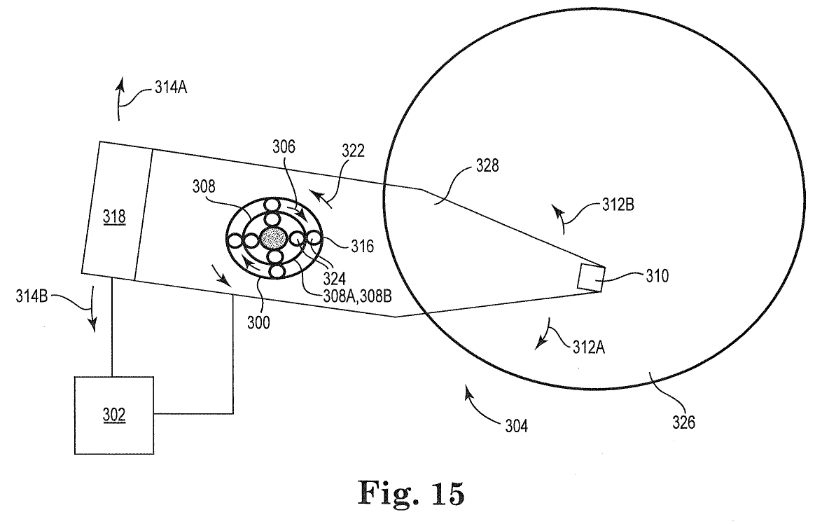

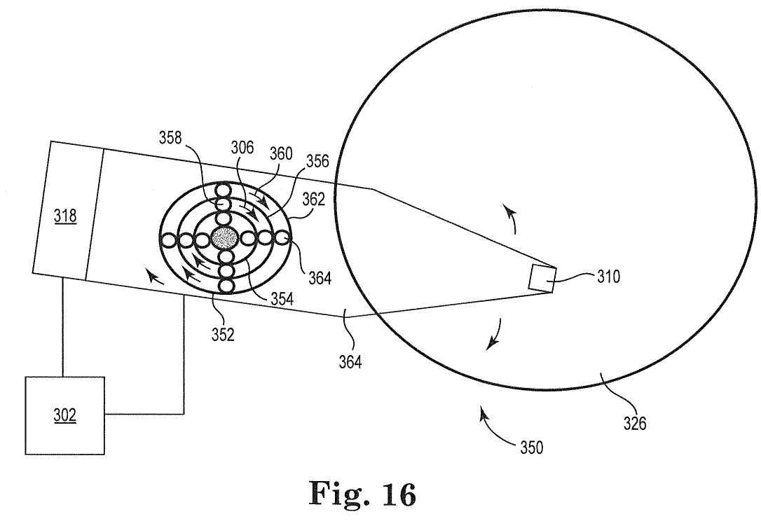

FIG. 9C illustrates a cross sectional view of pivot bearing 214 similar to FIG. 9A, except that the rotary actuator 202 is removed, in accordance with an embodiment of the present invention. During small finite rotations of the actuator via the voice coil motor (see e.g., FIGS. 15 and 16) torque is applied to the outer sleeve 215, which is transferred to the intermediate member 206 via the ball bearings 216. The torque allows the ball bearings 216 and 218 to rotate instead of slip, reducing or eliminating one of the components of the hysteresis. This configuration better transfers the voice coil motor torque into ball rotation and substantially reduces slip. In the case of a freely rotating intermediate member 206 as illustrated in FIG. 9C, no change is needed to an existing servo mechanical system. The pivot bearing 214 can simply be substituted for the current bearing cartridge.

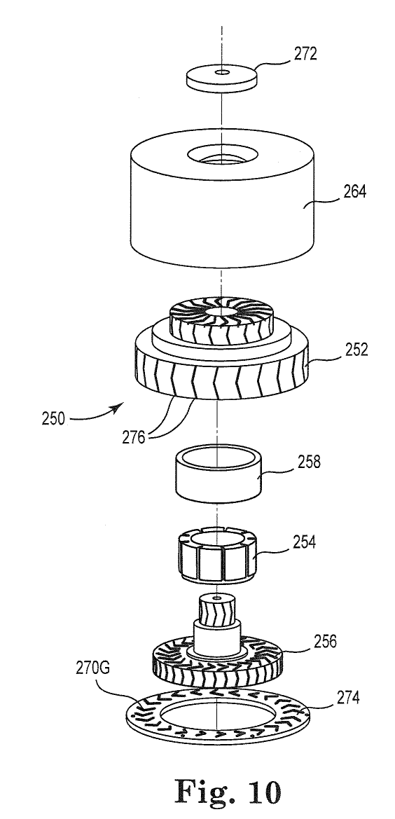

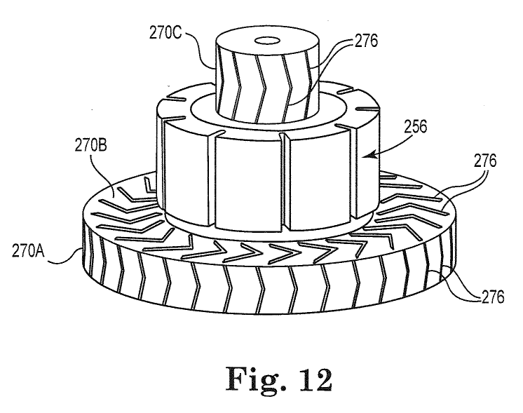

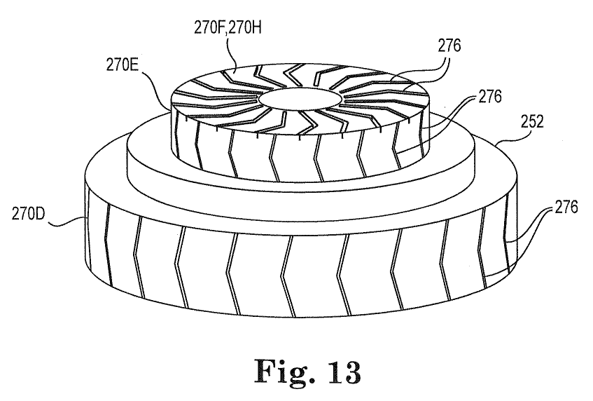

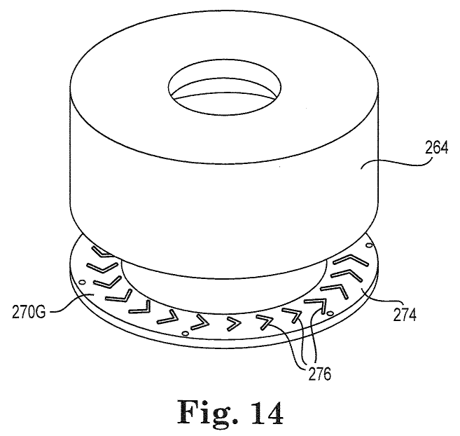

FIG. 10 through 14 illustrate various views of an alternate pivot bearing 250 in accordance with an embodiment of the present invention. The pivot bearing 250 is intended to operate at a high rotational speed sufficient to generate an air bearing or hydrodynamic film between the balls and the races. While this hydrodynamic embodiment is expected to have reduced hysteresis and improved life expectancy over conventional bearing structures, it will likely have greater run-out than the low rotational pivot bearing 100 discussed above. A drive spindle with an air bearing for a disk drive is disclosed in U.S. Pat. No. 6,362,932 (Bodmer et al.) which is hereby incorporated by reference.

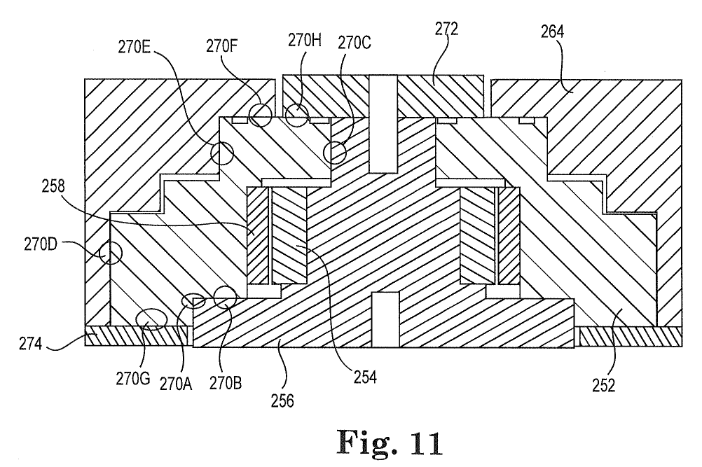

FIG. 11 provides a cross-sectional view of intermediate member 252 energized by rotary actuator 254 attached to the stationary bearing shaft 256. In the illustrated embodiment the rotary actuator 254 is a DC brushless motor and herringbone oil bearing surfaces. The intermediate member 252 contains a magnet assembly 258 to interface with the DC brushless motor 254.

The various interfaces 270A, 270B, 270C, 270D, 270E, 270F, 270G, 270H (collectively “270”) between the stationary bearing shaft 256, intermediate member 252 and outer sleeve bearing shell 264 include hydrodynamic features 276. In the illustrated embodiment, the hydrodynamic features 276 are herringbone grooves. Various hydrodynamic features between rotating members are disclosed in U.S. Pat. No. 6,157,515 (Boutaghou), which is hereby incorporated by reference.

Rotation of the intermediate member 252 creates an air bearing or hydrodynamic lift at the interfaces 270. The interfaces 270A, 270B, 270C are located between the intermediate member 252 and the stationary bearing shaft 256. The interfaces 270D, 270E, 270F are located between the intermediate member 252 and the outer sleeve bearing shell 264 connecting to a suspension arm. The interfaces 270G and 270H are located between the intermediate member 252 and the top bearing plate 272 and the bottom bearing plate 274, respectively. The intermediate member 252 is preferably rotated between 500 revolutions per minute (RPM) to several thousand RPM's.

The air bearing or hydrodynamic film generated at the interfaces 270 provides stiffness to the entire pivot bearing 250. In one embodiment, an oil bearing contributes a spring-like action between the moving intermediate member 252 and the stationary bearing shaft 256. The stiffness of the hydrodynamic oil bearing contributes to the translational stiffness of the pivot bearing 250. Herringbone surfaces are preferably fabricated on the bearing surfaces to pressurize the oil during the relative rotation of the mating surfaces.

Hydrodynamic bearings are very attractive as they offer both stiffness and high damping performance to the pivot bearing 250. Note since there are no rolling bearings the hysteresis effects are substantially eliminated.

FIG. 15 discloses a method of operating a pivot bearing 300 in accordance with embodiments of the present invention. Controller 302 operates rotary actuators (see e.g., FIGS. 4, 8, 9A, 9B) on the pivot bearing 300. The controller 302 can either be the servo controller that operates voice coil motor 318 provided with hard disk drive 304 or a separate controller. A general discussion of strategies for minimizing the effect of bearing friction that may be easily incorporated into existing disc drive designs is disclosed in U.S. Pat. No. 6,606,214 (Lin et al.), which is hereby incorporated by reference.

In one embodiment, the intermediate member 308 rotates continuous in one direction. The controller 302 adjusts the input current/voltage to the voice coil motor 318 to counteract any torque applied to the suspension arm 328 by the pivot bearing 300. The controller 302 can optionally be turned off during idle operations to save power.

In one embodiment, torque 306 generated by rotation of the intermediate member 308 is synchronized with torque 314A, 314B provided by voice coil motor 318. For example, if the transducer 310 needs to be moved in direction 312A, the controller 302 can rotate the intermediate member 308 in the same direction 306. The torque 306 provided by the intermediate member 308 augments the torque 314A on the outer sleeve 316 generated by the voice coil motor 318. Similarly, if the transducer 310 needs to move in the direction 312B, rotation of the intermediate member 308 can be reversed to augment torque 314B on the outer sleeve 316 generated by the voice coil motor 318.

In another embodiment, the intermediate member 308 is incrementally displaced, rather than continuously rotated. Small displacements of the intermediate member 308 reduce the impact of run-out in the pivot bearing 300 on the transducer 310. For example, the input current/voltage to the rotary actuators can be negatively proportional to the current applied to the voice coil motor 318. The negative current rotates the intermediate member 308 a small amount and allows for the ball bearings 324 to rotate in the desired direction to overcome the hysteresis effect. The angular rotation of the intermediate member 308 is preferably proportional to the angular rotation of the suspension arm 328. For example, if the suspension arm rotates about 10 minutes in direction 312B, the intermediate member 308 preferably rotates about 10 minutes in the opposite direction 306. In one embodiment the current is applied to the rotary actuators in the pivot bearing before the voice coil motor 318. This embodiment is particularly well suited for use where the rotary actuator operating intermediate member 308 is a voice coil motor, such as illustrated in FIG. 8B.

An opposite strategy can also be adopted that rotates the intermediate member 308 in the same direction as the voice coil motor 318. The input current/voltage to the rotary actuators on the pivot bearing 300 can have the same polarity as the input current to the voice coil motor 318. This method minimizes vibrations and allows for a smart dither-like behavior to be adopted for each disk drive track and zone.

In another embodiment, the controller 302 applies input current/voltage to the rotary actuators of the intermediate member 308 that is not necessarily the same or proportional to, the input current/voltage applied to the voice coil motor 318. For example, for current/voltage applied to the voice coil motor 318 within a certain range, a predetermined current/voltage is applied to the rotary actuators in the pivot bearing 300. In another embodiment, a predetermined current/voltage is applied to the rotary actuators in the pivot bearing 300 for each movement of the actuator arm 328.

In another embodiment, the controller 302 delivers one or more pulses to the rotary actuator immediately before, or at the same time, current/voltage is applied to the voice coil motor 318. The brief pulses are sufficient to overcome the hysteresis in the pivot bearing 300 so that the voice coil motor 318 can more easily position the transducer 310. The pulses are directional in that they displace the intermediate member 308 in a particular direction. The direction of displacement of the intermediate member 308 preferably corresponds to the direction of displacement the voice coil motor 318 needs to move actuator arm 328. The magnitude, direction, duration, and frequency of the pulses can be fixed or variable depending on a number of variables, such as for example the time lapsed since the last movement of the actuator aim 328, the temperature of the hard disk drive 304, and the like.

For example, the controller 302 receives instructions to move the transducer 310 to a particular location. Those instructions trigger delivery of voltage/current to both the rotary actuator and the voice coil motor 318. In the preferred embodiment, one or more pulses are sent to the rotary actuator immediately before voltage/current is applied to the voice coil motor 318. The pulses displace the intermediate member 308 slightly in the desired direction of rotation of the actuator arm 328, preferably overcoming any hysteresis effect in the pivot bearing 300 before the actuator arm 328 starts to move.

In another example, the controller 302 delivers a plurality of brief pulses to the rotary actuator to displace the intermediate member 308 in both directions immediately prior to the controller 302 activates the voice coil motor 318. The pulses cause the intermediate member 308 to oscillate a sufficient amount to overcome any hysteresis effect in the pivot bearing 300.

The input current/voltage to the rotary actuator(s) relative to the input current/voltage to the voice coil motor 318 is preferably calibrated. In one embodiment, the controller 302 positions the transducer 310 over a particular track on the rotating magnetic disk 326. The controller 302 then slowly ramps-up rotation of the intermediate member 308 in the direction 306. Input current to the voice coil motor 318 increases to counteract the torque 306 generated by the pivot bearing 300 in order to maintain the transducer 310 over the particular track. Rotation of the intermediate member 308 is then increased and the increased input current/voltage required by the voice coil motor 318 to counteract the increased torque 306 is recorded. The same calibration can be performed with the intermediate member 308 rotating in the opposite direction.

In an embodiment where the intermediate member 308 includes an upper intermediate member 308A and lower intermediate member 308B (collectively “308”), such as is illustrated in FIG. 8, the controller 302 preferably operates the upper and lower sleeves 308 independently. In one embodiment, the controller 302 positions the transducer 310 over a particular track on the rotating magnetic disk 326. The controller 302 then slowly ramps-up rotation of the upper and lower sleeves 308 in opposite directions so that the transducer 310 is maintained over the particular track. Input current to the voice coil motor 318 may be required to compensate for transient torques from the upper and lower sleeves 308 during the initial start-up phase. Eventually, the required rotation speeds of the upper and lower sleeves 308 are calibrated so that the torque applied by the pivot bearing 300 is minimized or eliminated. During the calibration process, torque applied by the pivot bearing 300 can be measured by the input current to the voice coil motor 318 required to maintain the transducer 310 over the particular track on the magnetic disk 326.

FIG. 16 illustrates a disk drive 350 with a pivot bearing 352, such as illustrated in FIG. 9B, with a first intermediate member 354 and a second intermediate member 356. As discussed above, the controller 302 slowly ramps-up rotation of the first and second intermediate members 354, 356 in opposite directions so that the transducer 310 is maintained over a particular track on the magnetic disk 326. Input current to the voice coil motor 318 may be require to compensate for transient torques from the first and second intermediate members 354, 356 during the initial start-up phase. Eventually, the required rotation speeds of the first and second intermediate members 354, 356 are calibrated so that the torque applied to the suspension arm 364 by the pivot bearing 352 is minimized or eliminated.

Since only a portion of the torque 306 generated by the first intermediate member 354 is transferred to the second intermediate member 356 by ball bearings 358, the rotational speed of the second intermediate member 356 required to neutralize the torque 306 is likely less than the rotational speed of the first intermediate member 354.

In another embodiment, the first intermediate member 354 is rotated continuously. No rotary actuator is provided for the second intermediate member 356. Some portion of torque 306 generated by the first intermediate member 354 is transferred to the second intermediate member 356 by ball bearings 358. Some portion of torque 360 on the second intermediate member 356 is also transferred to the outer sleeve 362 by the ball bearings 364. Since the second intermediate member 356 absorbs some of the torque 306 generated by the first intermediate member 354, the portion of the toque 306 applied to the suspension arm 364 is reduced. The second intermediate member 356 acts as a buffer between the torque 306 and the suspension arm 364.

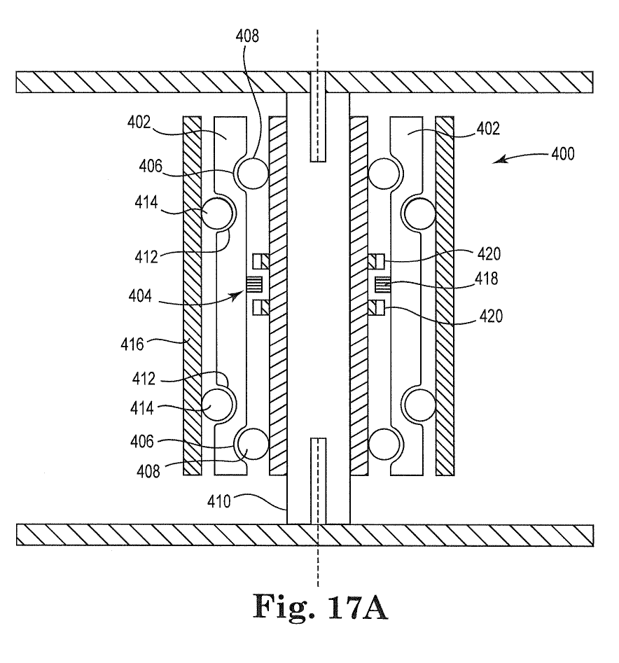

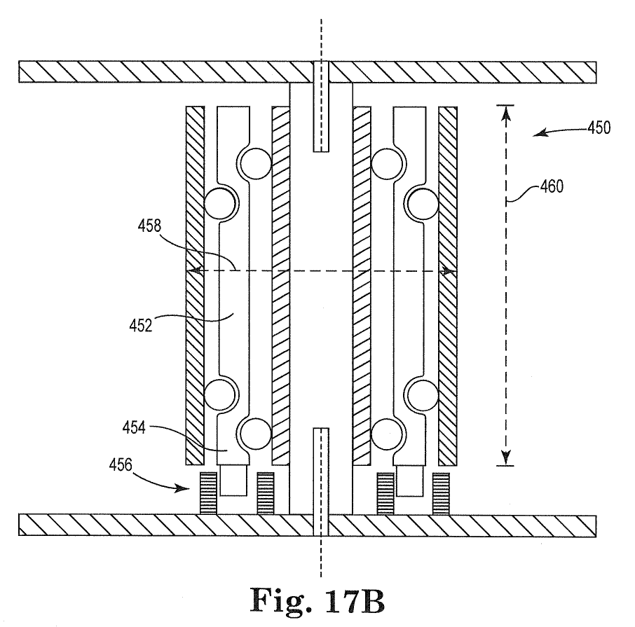

FIG. 17A is a schematic illustration of an alternate pivot bearing 400 wherein the intermediate member is a rotatable race 402 driven by rotary actuator 404 in accordance with an embodiment of the present invention. In the illustrated embodiment, rotary actuator 404 is a voice coil motor with coil 418 mounted to stationary shaft 410 and the magnets 420 are mounted to rotatable race 402. Rotatable race 402 includes recesses 406 that support intermediate member bearing set 408 against stationary shaft 410. Recesses 412 support outer sleeve bearing set 414 against outer sleeve 416. The preload on the pivot bearing 400 is preferably oriented radially relative to the stationary shaft 410.

Rotation of the rotatable race 402 causes the bearing sets 408, 414 to be in motion, eliminating the starting torque generated in a conventional pivot bearing. The moving bearings 408, 414 also displace the lubricant and prevent a meniscus film of lubricant that causes stiction from forming. As a result the transient torque observed during start-up from a resting state, or when the direction of rotation is reversed, is substantially eliminated. Any of the control schemes discussed herein can be used with the pivot bearing 400 of FIG. 17A.

FIG. 17B is a schematic illustration of pivot bearing 450 with a rotatable race 452 generally as illustrated in FIG. 17A. Rotary actuator 456 is located at distal end 454 of rotatable race 452 in accordance with another embodiment of the present invention. The pivot bearing 450 preferably has the same diameter 458 of a conventional pivot bearing. Height 460 of the pivot bearing 450 is optionally reduced to compensate for the space consumed by the rotary actuator 456. Consequently, pivot bearing 450 can be used with existing disk drives with minimal redesign. Again, any of the control schemes discussed herein can be used with the pivot bearing 450.

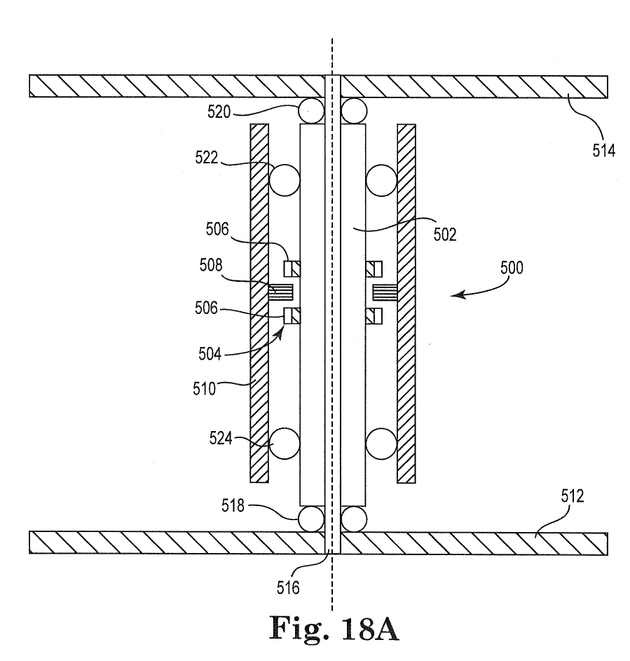

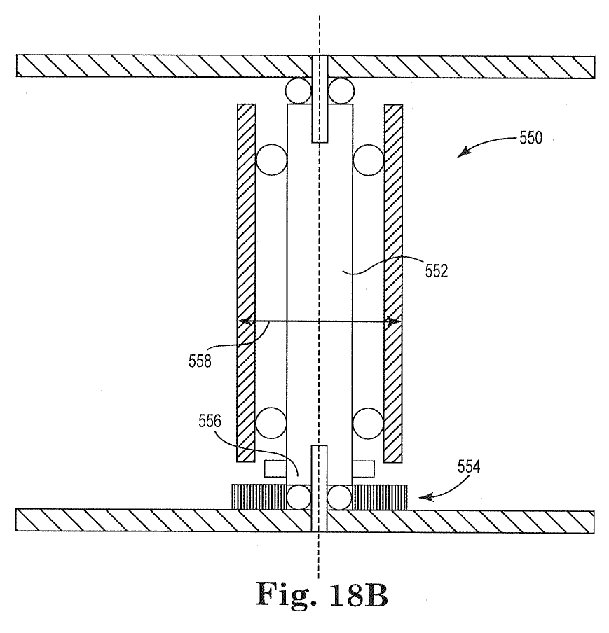

FIG. 18A a schematic illustration of an alternate pivot bearing 500 where the rotatable intermediate member is a rotatable center shaft 502 driven by rotary actuator 504 in accordance with an embodiment of the present invention. In the illustrated embodiment, rotary actuator 504 is a voice coil motor with magnets 506 mounted to center shaft 502 and coil 508 are mounted to outer sleeve 510.

The rotatable center shaft 502 is retained to base plate 512 and cover plate 514 by stationary shaft 516. Bearing sets 518, 520 are located between the rotatable center shaft 502 and the plates 512, 514. The stationary shaft 516 can be used to provide an axial pre-load on the bearing sets 518, 520. A radial preload can also be applied to the bearing sets 522, 524. Rotation of the rotatable center shaft 502 causes the bearing sets 522, 524 to be in motion, eliminating the starting torque generated in a conventional pivot bearing. Any of the control schemes discussed herein can be used with the pivot bearing 500 of FIG. 17A.

FIG. 18B is a schematic illustration of pivot bearing 550 where the intermediate member is a rotatable center shaft 552 generally as illustrated in FIG. 18A. Rotary actuator 554 is located at distal end 556 of rotatable center shaft 552 in accordance with another embodiment of the present invention. The pivot bearing 550 preferably has the same diameter 558 of a conventional pivot bearing. Consequently, pivot bearing 550 can be used with existing disk drives with minimal redesign. Again, any of the control schemes discussed herein can be used with the pivot bearing 550.

Where a range of values is provided, it is understood that each intervening value, to the tenth of the unit of the lower limit unless the context clearly dictates otherwise, between the upper and lower limit of that range and any other stated or intervening value in that stated range is encompassed within the inventions. The upper and lower limits of these smaller ranges which may independently be included in the smaller ranges is also encompassed within the inventions, subject to any specifically excluded limit in the stated range. Where the stated range includes one or both of the limits, ranges excluding either both of those included limits are also included in the inventions.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A pivot bearing for use in a rotary actuator of a hard disk drive, the pivot bearing comprising:
at least one stationary shaft;
at least one intermediate member pivotally connected to the stationary shaft by an intermediate member bearing;
at least one outer sleeve pivotally connected to the intermediate member by an outer sleeve bearing; and
at least one rotary actuator adapted to angularly displace at least one of the intermediate members relative to the stationary shaft.

2. The pivot bearing of claim 1 wherein the intermediate member is one of a bearing race, an inner sleeve, or a center shaft.

3. The pivot bearing of claim 1 comprising hydrodynamic features at one or more interface between the stationary shaft, the intermediate member, and the outer sleeve.

4. The pivot bearing of claim 1 wherein the rotary actuator rotates the intermediate member at about 1 revolution per minute to about 10 revolutions per minute.

5. The pivot bearing of claim 1 wherein the intermediate member comprises an upper portion with a first rotary actuator and a lower portion with a second rotary actuator.

6. The pivot bearing of claim 5 wherein the upper portion of the intermediate member is adapted to angularly displace in a first direction and the lower portion of the intermediate member is adapted to angularly displace in an opposite direction.

7. The pivot bearing of claim 1 comprising:
a first intermediate member pivotally connected to the stationary shaft by a first intermediate member bearing;
a second intermediate member pivotally arranged concentrically, and connected to, the first intermediate member by a second intermediate member bearing; and
first and second rotary actuators adapted to angularly displace the first and second intermediate members relative to the stationary shaft.

8. The pivot bearing of claim 7 comprising a controller programmed to angularly displace the first intermediate member in a first direction and the second intermediate member in an opposite direction.

9. The pivot bearing of claim 1 wherein a relationship of torque applied to the pivot bearing to angular displacement of the pivot bearing is substantially linear.

10. The pivot bearing of claim 1 comprising a controller programmed to actuate the rotary actuator only during position critical displacement.

11. The pivot bearing of claim 1 comprising a controller programmed to deliver one or more pulses to the rotary actuator.

12. A pivot bearing for use in a rotary actuator of a hard disk drive, the pivot bearing comprising:
at least one stationary shaft;
at least one intermediate member pivotally connected to the stationary shaft by an intermediate member bearing; and
at least one outer sleeve pivotally connected to the intermediate member by an outer sleeve bearing.

13. A method of operating a hard disk drive comprising the steps of:
supporting at least one suspension arm by an outer sleeve of a pivot bearing;
angularly displacing an intermediate member on the pivot bearing arranged concentric with the outer sleeve relative to a stationary shaft; and
angularly displacing the suspension arms and the outer sleeve independently from the angular displacement of the intermediate member to position magnetic transducers attached to the suspension arms over selected information tracks on rotating magnetic disks.

14. The method of claim 13 comprising the step of rotating the intermediate member at about 1 revolution per minute to about 10 revolutions per minute.

15. The method of claim 13 comprising the step of angularly displacing the intermediate member at a rate sufficient to create an air bearing between at least one of the intermediate member and the stationary shaft or the intermediate member and the outer sleeve.

16. The method of claim 13 comprising angularly displacing an upper portion of the intermediate member in a first direction and angularly displacing a lower portion of the intermediate member in a second opposite direction.

17. The method of claim 13 comprising the steps of:
angularly displacing a first intermediate member pivotally connected to the stationary shaft in a first direction; and
angularly displacing a second intermediate member arranged concentrically, and pivotally connected to, the first intermediate member in a second opposite direction.

18. The method of claim 13 comprising actuating a rotary actuator that angularly displaces the intermediate member only during position critical displacement.

19. The method of claim 13 comprising angularly displacing the intermediate member an amount proportional to, but in an opposite direction of, angular displacement of the outer sleeve.

20. The method of claim 13 comprising delivering one or more pulses to the rotary actuator immediately prior, or simultaneous with, delivering current or voltage to the voice coil motor.
